(19) United States
(12) Patent Application Publication
(10) Pub. No.: US 2015/0110310 A1
(43) Pub. Date: Apr. 23, 2015

(54) METHOD FOR REPRODUCING AN ACOUSTICAL SOUND FIELD

(71) Applicant: Oticon A/S, Smorum (DK)

(72) Inventor: Pauli MINNAAR, Smorum (DK)

(73) Assignee: Oticon A/S, Smorum (DK)

(21) Appl. No.: 14/516,234

(22) Filed: Oct. 16, 2014

(30) Foreign Application Priority Data
Oct. 17, 2013 (EP) 13189040.2

(51) Int. Cl. H04S 7/00; H04R 5/00

(52) U.S. Cl. CPC H04S 7/302; H04R 5/00
USPC 381/307

(57) ABSTRACT

The application relates to a method of reproducing an acoustical sound field to a listener at a first location, to a method of testing a hearing assistance system, and to a hearing assistance test system. The method comprises 1) Determining a transfer function from each loudspeaker unit of the loudspeaker array to all microphone units of the microphone array, thereby providing a set of transfer functions; 2) Inverting the set of transfer functions and determining a system of optimal filters; 3) Placing the microphone array in a possible, intended position of the listener's head in a particular sound scene at a second location and recording sound of the particular sound scene at the second location; 4) Determining the loudspeaker signals of the particular sound scene configured to be played to the listener at the first location by the loudspeaker array by convolving the inverted system of optimal filters with the recorded signals.

### TECHNICAL FIELD

The present application relates to sound field reproduction. The disclosure relates specifically to a method of reproducing an acoustical sound field.

The application furthermore relates to a sound field reproduction system. The application further relates to a data processing system comprising a processor and program code means for causing the processor to perform at least some of the steps of the method.

Embodiments of the disclosure may e.g. be useful in applications such as sound reproduction systems, virtual reality systems, mobile telephones, hearing assistance systems, e.g. hearing aids, headsets, ear phones, active ear protection systems, etc. Other applications may e.g. be handsfree telephone systems, teleconferencing systems, public address systems, karaoke systems, classroom amplification systems, etc.

### BACKGROUND

The following account of the prior art relates to one of the areas of application of the present application, hearing aids.

When designing hearing aids, it is necessary to test their performance in listening tests. In order to claim that new features give a benefit, this has to be shown by testing directly on end users. The existing test methods are however either too far removed from real life listening, or are much too inaccurate and uncertain.

Traditionally laboratory test are done with relatively simple loudspeaker setups. As an example the Danish sentence test Dentate is commonly used (see e.g. [Wagner et al.; 2003]). In this test three loudspeakers are placed to the sides and behind the listener for creating noise. This noise is typically “unmodulated speech shaped” noise. From a loudspeaker in front of the listener the “target” speech is being played. The task of the listener is to repeat the words from the target speaker. If the words are heard correctly, the speech is gradually turned down until a threshold is reached. This test is quite accurate, but it is not very representative of what happens in real-life listening.

In another type of testing (called field testing), end users are sent home with a set of hearing aids and a questionnaire. The listeners have to find particular listening situations and fill out the questionnaire, typically within a 2 week period. This test can be said to represent real-life listening, but it is very uncertain what the users actually listened too.

In order to get both a high accuracy in the measurement and realism in the test, it is necessary to be able to reproduce real-life listening situations in the laboratory. These have to be well-defined and repeatable in order to allow for comparisons between different hearing aid settings and hearing aid types. Of cause it is possible to place several loudspeakers around the listener and to use stereo mixing techniques to create sound scenes. One can also use a spherical loudspeaker array and High Order Ambisonics (HOA), Wave Field Synthesis (WFS) or Vector-based Amplitude Panning (VBAP) methods to implement simulated rooms and virtual sound sources around the listener. However, these methods are not able to reproduce an actual real world sound scene.

Instead this can be done by recording the sound field in a real listening situation with a microphone array. By far the most commonly used method for reproducing such recordings in a spherical loudspeaker array, is by employing HOA (see e.g. [Favrot et al.; 2010] and [Daniel; 2000]). This method cannot be used if there are sound sources that are both far away and close to the listener, though. Furthermore, the microphone and the loudspeaker arrays have to be spherical and the calibration procedure can be very cumbersome.

Therefore, a more elegant method is needed for reproducing the sound field around a listeners head under real-life listening conditions in the laboratory. The method should preferably be easy to calibrate and provide the best possible sound field reproduction with the given amount of microphones and loudspeakers available.

U.S. Pat. No. 7,336,793 B2 describes a reproduction system that creates a desired sound field from an array of sound sources arranged on a panel. The underlying technology with which the sound field is controlled is Wave Field Synthesis (WFS). This well-known technology, that is typically used with a line array of loudspeakers, is here extended to a flat panel. WFS is particularly well-suited for reproducing a sound field in a relatively large listening area—such as an audience (of 10 or more people). A disadvantage of the WFS method is that the reproduction errors are spread across the whole of the listening area. This is in contrast to the method of the present disclosure, where the errors are largest outside the listening area and smallest in the centre of the listening area. Another disadvantage of the WFS method is that a very large amount of loudspeakers are needed and that the reproduction generally is limited to the horizontal plane. Therefore, WFS is not suitable for testing hearing aid technology, where a small listening area (for one person), is required.

US 2001/0040969 describes a sound reproduction system, for testing hearing and hearing aids. Several methods are mentioned for recording and playback of the sound, including a “three dimensional microphone” (the SoundField Mk-V) that is typically used for recording 4-channel Ambisonics B-format signals. The method of the present disclosure does not, however, use Ambisonics or, for that matter, High Order Ambisonics (HOA) in any part of the implementation.

### SUMMARY

The present method of sound field reproduction is based on providing (e.g. theoretically or physically measuring) and inverting (e.g. by a modelling tool) transfer functions of the reproduction system.

An object of the present application is to provide an improved sound field reproduction. A further object of the present disclosure is to provide an alternative method of reproducing a sound field. It is a further object to provide a method of reproducing sound fields from different sound scenes naturally at a particular location (e.g. for adapted for playing or testing). In particular, it is an object to provide reliable sound field reproduction suitable for testing a hearing assistance device. An object of an embodiment of the disclosure is to provide sound field reproduction that is natural for the user or test person allowing the user or test person to orient his or her head according to will while maintaining a natural sound perception (reflecting the localization cues perceived by a normally hearing person in a corresponding real situation). An object of an embodiment of the disclosure is to provide an improved sound field reproduction in a specific listening area covering the user or test person at a large range of frequencies below a threshold frequency, e.g. at frequencies below 4 kHz. An object of an embodiment of the disclosure is to provide sound field reproduction method or system that is suitable as a development tool for audio processing algorithms, e.g. for sound reproduction systems, e.g. hearing assistance devices.

Objects of the application are achieved by the invention described in the accompanying claims and as described in the following.

### A Method of Reproducing a Sound Field:

A method of sound field reproduction implementing a (e.g., but not necessarily, spherical) microphone array in a (e.g., but not necessarily, spherical) loudspeaker array is proposed. The method uses direct inversion of measured (or otherwise determined) transfer functions. The goal of the method is to reproduce the signals at all the microphone capsules of a microphone array optimally (in a least squares sense). In the present application, the terms ‘microphone capsule’ and ‘microphone’ are used interchangeably to define a single ‘microphone unit’ for converting an input sound to an electric input signal.

In order to create a number of different sound scenes (e.g. representing particular listening situations or environments) the following steps need to be performed:

1) In a setup or calibration step, impulse responses (IR) are determined (e.g. measured) from each loudspeaker of a loudspeaker array to all microphone capsules of a microphone array.
2) This set of transfer functions is then inverted (cf. e.g. [Minaar et al.; 2013]) to find a system of optimal filters that minimize errors (e.g. in a least squares sense).
3) The sound in a particular sound scene is recorded by placing the microphone array in a possible, intended, position of the listeners head.
4) In order to determine the loudspeaker signals of the particular sound scene (to be played for a user when he or she intends to listen to the sound field of the particular listening situation at another location), the inverted system of optimal filters is convolved with the recorded signals (see e.g. [Klinkeby et al; 1998]).

In an aspect of the present application, an object of the application is achieved by a method of reproducing an acoustical sound field to a listener at a first location using a sound reproduction system comprising a microphone array comprising a plurality of microphone units and a loudspeaker array comprising a plurality of loudspeaker units. The method comprises,

1) Determining a transfer function from each loudspeaker unit of the loudspeaker array to all microphone units of the microphone array, thereby providing a set of transfer functions, when said microphone array is located in a primary volume at an intended position of the listener's head during listening to said sound field;
2) Inverting the set of transfer functions and determining a system of optimal filters;
3) Placing the microphone array in a an intended position of the listener's head in a particular sound scene at a second location and recording sound of the particular sound scene at the second location, thereby providing a particular sound scene recording;
4) Determining the loudspeaker signals of the particular sound scene configured to be played to the listener at the first location by the loudspeaker array by convolving the inverted system of optimal filters with the recorded signals.

Even though the goal of the method described above is to reproduce the signals at the microphone positions, the sound field (e.g. in a sphere) around the microphone is also correct (such sphere e.g. corresponding to at least one user's head). The extent to which this is true depends on frequency, though. At low frequencies, the sound field is correct in a large area around the microphone (and the listener's head). As frequency is increased, this area (volume) gets smaller and smaller. This means that at low frequencies both the amplitude and the phase are correct, whereas at high frequencies the amplitude is correct, but the phase cannot be controlled precisely. Nonetheless, when listening to wideband stimuli, sound localisation is very well reproduced, since low frequency Interaural Time Differences (ITDs) are intact.

An advantage of the method is that since the (true) sound field around the head has been reproduced (for a particular listening situation), a listener is allowed to freely move the head. Hence, the system is very well suited for testing hearing aids on the ears of an end user.

The method has advantages over the commonly-used HOA in that no restrictions are placed on the configuration of the arrays, i.e. they do not have to be spherical. Another advantage is that, all transducers (microphones and loudspeakers) are taken into account and thus the calibration of the system is included in the optimisation. Furthermore, there are no limitations to recording close sources. This is in contrast to HOA that relies on far-field assumptions.

Similar methods have been described and investigated by e.g. [Fazi and Nelson; 2007] and [Chang et al.; 2010].

The term ‘determining a transfer function’ is intended to cover time-domain as well as frequency domain transfer functions, such as ‘determining an impulse response’ or ‘determining a frequency response’, or other equivalent expressions.

In an embodiment, the first location is a location with predefined acoustic properties. In an embodiment, the first location is a location with predefined relatively low reverberation, e.g. an acoustically attenuated room, e.g. a room equipped with acoustically attenuating (wall) elements, e.g. a substantially anechoic room.

In an embodiment, the second location is equal to the first location.

Preferably, however, the second location is different from the first location. In an embodiment, the second location comprises a particular sound scene representing an intended listening situation, e.g. of a user of a hearing assistance device or another user (e.g. a user of a game or device or a participant in an educational or other entertainment activity).

In an embodiment, step 1) comprises 1a) Positioning the microphone array and the loudspeaker array in a predetermined geometrical configuration, the microphone array being placed at an intended position of a listener's head when listening to said acoustical sound field. Preferably, the microphone array is located so as to mimic the position of the listener's head to achieve that the sound field is optimized in a volume of the location where the listener is intended to position his or her head during listening to the particular sound scene recording.

In an embodiment, step 1) comprises measuring at least some of said transfer functions. In a preferred embodiment, step 1) is a calibration step, wherein each transfer function is measured.

In an embodiment, step 1) is performed at said first location. Preferably, step 1) is performed at the first location, where the particular sound scene recording (recorded at the second location) is intended to be presented to the listener. In an embodiment, some, such as a majority or all of said transfer functions are measured.

As described, the transfer functions from each loudspeaker unit to all microphone units should ideally be measured with the playback system to be used for sound recording. It is however also possible to calibrate the system without taking into account the transfer functions of the loudspeaker- and microphone responses in the specific playback room. Instead, a theoretical model of the acoustics of the reproduction system can be used, such as that described by [Duda and Martens; 1998] for a hard sphere. With this model, transfer functions can be obtained by considering the relative angle (azimuth and elevation angle) of each microphone and each loudspeaker in the reproduction setup. In this way a more “neutral” system can be created, where the loudspeaker signals can be played in another system having the same (geometrical) configuration. If desired, the loudspeakers (in the playback room) can then be equalized by measuring responses with a single microphone in the listening position.

In an embodiment, step 1) comprises theoretically determining at least some of said transfer functions. In an embodiment, step 1) comprises theoretically determining such transfer function, e.g. based on a model of the geometrical configuration of the loudspeaker—microphone setup. In an embodiment, some, such as a majority or all of said transfer functions are theoretically determined.

In an embodiment, step 3) is repeated to provide a number N_{ssc} of particular sound scene recordings. In an embodiment, a number N_{ssc} of different particular sound scenes are recorded, resulting a number N_{ssc} of particular sound scene recordings. Thereby a number of different particular sound scenes recorded at the same or different locations can be reproduced via the sound field system for a listener located in the first location (e.g. a test or other environment).

In an embodiment, the method comprises providing that the listener wears (is equipped with) a hearing assistance system configured to pick up and process the acoustic sound field.

### A Method of Testing a Hearing Assistance Device in a Sound Field:

In a further aspect, a method of testing a hearing assistance system in a sound field is provided. The hearing assistance system comprises one or more hearing assistance devices adapted for being fully or partially located on or implanted in the head of a listener. The method comprises the steps of the method according to method of reproducing an acoustical sound field to a listener as described above, in the detailed description of embodiments and in the claims, the method of testing a hearing assistance system further comprising:

T1) Providing the listener with said one or more hearing assistance devices;
T2) Locating the listener at said first location so that the listener's head is positioned in said primary volume;
T3) Providing one or more of said particular sound scene recordings;
T4) Playing said one or more particular sound scene recordings for the user.

In an embodiment, the method comprises providing a user interface accessible to the listener, wherein the user interface is configured to allow the listener to indicate an opinion on the currently played particular sound scene recording.

In an embodiment, the method comprises providing a user interface accessible to the listener. In an embodiment, the user interface is configured to allow the listener to indicate an opinion on the currently played particular sound scene recording. In an embodiment, the user interface is configured to allow the listener to switch between different particular sound scene recordings. In an embodiment, the user interface is configured to allow the listener to switch between different processing algorithms.

### A Hearing Assistance Test System.

In an aspect, a hearing assistance test system comprising a sound reproduction system and a control unit suited for testing a hearing assistance system of a user at a first location is furthermore provided by the present application, the sound reproduction system comprising
A loudspeaker array comprising a plurality of loudspeaker units, the loudspeaker array being adapted to be located in a predefined geometrical configuration surrounding said listener;
A control unit operatively connected to said loudspeaker array and configured to play individual loudspeaker signals of each loudspeaker unit of the loudspeaker array of a particular sound scene as determined according to the method described above, in the detailed description and drawings and in the claims, said individual loudspeaker signals being configured to be played to the listener when said listener is located at said first location; the control unit comprising
   a listener user interface allowing said listener to interact with the control unit.

It is intended that some or all of the process features of the method described above, in the ‘detailed description of embodiments’ or in the claims can be combined with embodiments of the system, when appropriately substituted by a corresponding structural feature and vice versa. Embodiments of the system have the same advantages as the corresponding method.

In an embodiment, the sound reproduction system comprises one or more of particular sound scene recordings.

In an embodiment, the control unit comprises a programming interface to said hearing assistance system allowing a user to modify processing in the hearing assistance system.

In an embodiment, the hearing assistance test system is configured to allow the listener to initiate and control the sound reproduction of said one or more particular sound scene recordings, e.g. to switch between two sound scene recordings from said listener user interface. In an embodiment, the hearing assistance test system is configured to allow the listener to evaluate the performance of a number of different processing algorithms of the one or more hearing assistance devices (or intended for being used in the one or more hearing assistance devices) in said one or more particular sound scenes.

In an embodiment, the hearing assistance test system is configured to allow the listener to modify the processing in the hearing assistance system, e.g. in the one more hearing assistance devices, via the listener user interface.

In an embodiment, the loudspeaker array comprises at least 5 loudspeaker units, such as at least 10, such as at least 20, such as at least 30 loudspeaker units.

In an embodiment, the hearing assistance test system comprises a microphone array comprising a multitude of microphone units and adapted for recording a sound field at said one or more particular sound scenes. In an embodiment, the microphone array comprises at least 5 microphone units, such as at least 10, such as at least 20, such as at least 30 microphone units.

In an embodiment, the number of loudspeaker units and the number of microphone units are substantially equal. In an embodiment, the number of loudspeaker units Nₛₚₖ and the number of microphone units N_{mic} are within 10% of each other, e.g. equal to each other.

In an embodiment, the hearing assistance test system comprises the hearing assistance system. In an embodiment, the hearing assistance system comprises a hearing assistance device. In an embodiment, the hearing assistance system comprises left and right hearing assistance device adapted for being located at or in a user's left and right ear, respectively. In an embodiment, the left and right hearing assistance devices are adapted to implement a binaural listening system, e.g. a binaural hearing aid system.

In an embodiment, the hearing assistance system comprises an auxiliary device, e.g. an audio gateway and/or a cellphone, e.g. a SmartPhone.

In an embodiment, the hearing assistance system is adapted to establish a communication link between the left and right hearing assistance devices, and/or the auxiliary device, and/or the control unit to provide that information (e.g. control and status signals, possibly audio signals) can be exchanged or forwarded from one to the other.

In an embodiment, the hearing assistance device is adapted to provide a frequency dependent gain to compensate for a hearing loss of a user. In an embodiment, the hearing assistance device comprises a signal processing unit for enhancing the input signals and providing a processed output signal. Various aspects of digital hearing aids are described in [Schaub; 2008].

In an embodiment, the hearing assistance device comprises an antenna and transceiver circuitry for wirelessly receiving a direct electric input signal from another device, e.g. a communication device or another hearing assistance device. In an embodiment, the hearing assistance device comprises a (possibly standardized) electric interface (e.g. in the form of a connector) for receiving a wired direct electric input signal from another device, e.g. a communication device or another hearing assistance device.

In an embodiment, the wireless link is based on a standardized or proprietary technology. In an embodiment, the wireless link is based on Bluetooth technology (e.g. Bluetooth Low-Energy technology).

In an embodiment, the hearing assistance device is portable device, e.g. a device comprising a local energy source, e.g. a battery, e.g. a rechargeable battery.

In an embodiment, the hearing assistance device comprises a forward or signal path between an input transducer (microphone system and/or direct electric input (e.g. a wireless receiver)) and an output transducer. In an embodiment, the signal processing unit is located in the forward path. In an embodiment, the signal processing unit is adapted to provide a frequency dependent gain according to a user's particular needs. In an embodiment, the hearing assistance device comprises an analysis path comprising functional components for analyzing the input signal (e.g. determining a level, a modulation, a type of signal, an acoustic feedback estimate, etc.). In an embodiment, some or all signal processing of the analysis path and/or the signal path is conducted in the frequency domain. In an embodiment, some or all signal processing of the analysis path and/or the signal path is conducted in the time domain.

In an embodiment, the hearing assistance device further comprises other relevant functionality for the application in question, e.g. feedback suppression, compression, noise reduction, etc.

In an embodiment, the hearing assistance device comprises a listening device, e.g. a hearing aid, e.g. a hearing instrument, e.g. a hearing instrument adapted for being located at the ear or fully or partially in the ear canal of a user, e.g. a headset, an earphone, an ear protection device or a combination thereof.

### A Computer Readable Medium:

In an aspect, a tangible computer-readable medium storing a computer program comprising program code means for causing a data processing system to perform at least some (such as a majority or all) of the steps of the method described above, in the ‘detailed description of embodiments’ and in the claims, when said computer program is executed on the data processing system is furthermore provided by the present application. In addition to being stored on a tangible medium such as diskettes, CD-ROM-, DVD-, or hard disk media, or any other machine readable medium, and used when read directly from such tangible media, the computer program can also be transmitted via a transmission medium such as a wired or wireless link or a network, e.g. the Internet, and loaded into a data processing system for being executed at a location different from that of the tangible medium.

### A Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

### DEFINITIONS

In the present context, a ‘hearing assistance device’ refers to a device, such as e.g. a hearing instrument or an active ear-protection device or other audio processing device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. A ‘hearing assistance device’ further refers to a device such as an earphone or a headset adapted to receive audio signals electronically, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing assistance device may be configured to be worn in any known way, e.g. as a unit arranged behind the ear with a tube leading radiated acoustic signals into the ear canal or with a loudspeaker arranged close to or in the ear canal, as a unit entirely or partly arranged in the pinna and/or in the ear canal, as a unit attached to a fixture implanted into the skull bone, as an entirely or partly implanted unit, etc. The hearing assistance device may comprise a single unit or several units communicating electronically with each other.

More generally, a hearing assistance device comprises an input transducer for receiving an acoustic signal from a user's surroundings and providing a corresponding input audio signal and/or a receiver for electronically (i.e. wired or wirelessly) receiving an input audio signal, a signal processing circuit for processing the input audio signal and an output means for providing an audible signal to the user in dependence on the processed audio signal. In some hearing assistance devices, an amplifier may constitute the signal processing circuit. In some hearing assistance devices, the output means may comprise an output transducer, such as e.g. a loudspeaker for providing an air-borne acoustic signal or a vibrator for providing a structure-borne or liquid-borne acoustic signal. In some hearing assistance devices, the output means may comprise one or more output electrodes for providing electric signals.

In some hearing assistance devices, the vibrator may be adapted to provide a structure-borne acoustic signal transcutaneously or percutaneously to the skull bone. In some hearing assistance devices, the vibrator may be implanted in the middle ear and/or in the inner ear. In some hearing assistance devices, the vibrator may be adapted to provide a structure-borne acoustic signal to a middle-ear bone and/or to the cochlea. In some hearing assistance devices, the vibrator may be adapted to provide a liquid-borne acoustic signal to the cochlear liquid, e.g. through the oval window. In some hearing assistance devices, the output electrodes may be implanted in the cochlea or on the inside of the skull bone and may be adapted to provide the electric signals to the hair cells of the cochlea, to one or more hearing nerves, to the auditory cortex and/or to other parts of the cerebral cortex.

A ‘listening system’ refers to a system comprising one or two hearing assistance devices, and a ‘binaural listening system’ refers to a system comprising one or two hearing assistance devices and being adapted to cooperatively provide audible signals to both of the user's ears. Listening systems or binaural listening systems may further comprise ‘auxiliary devices’, which communicate with the hearing assistance devices and affect and/or benefit from the function of the hearing assistance devices. Auxiliary devices may be e.g. remote controls, audio gateway devices, mobile phones, public-address systems, car audio systems or music players. Hearing assistance devices, listening systems or binaural listening systems may e.g. be used for compensating for a hearing-impaired person's loss of hearing capability, augmenting or protecting a normal-hearing person's hearing capability and/or conveying electronic audio signals to a person.

### Further Applications:

Besides testing hearing assistance devices, e.g. hearing aids, the concepts systems and methods described in the current disclosure can be used for other purposes, e.g. for testing many other types of products. This could include mobile devices, such as mobile phones and portable computers, headsets, headphones with active control of sound, gaming devices with microphones, etc. In all these cases, it may be desirable to create a realistic sound field within which to test the performance of the device. It may also be tested with a person (using the device) in the sound field. In this way users can experience the product as it would work in a real-life acoustical situation.

The concepts of the present disclosure can e.g. be used in a general recording and playback system, for creating very realistic reproductions of real listening situations. Thus it can be used for music concerts, live sports events, acoustical monitoring, surveillance, etc. The sound reproduction can also be combined with a visual display. The visual component—that e.g. can be captured by a (e.g. spherical) array of cameras—can be projected on a screen around the viewer.

The above-mentioned system can also be used for testing hearing in general. Thus it is not necessarily required for the listener to wear any hearing device. Furthermore, there are no requirements that the listener has to be hearing impaired, as any normal-hearing person can hear the reproduced sound field as he/she would in real life.

Further objects of the application are achieved by the embodiments defined in the dependent claims and in the detailed description of the invention.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element or intervening elements may be present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF DRAWINGS

The disclosure will be explained more fully below in connection with a preferred embodiment and with reference to the drawings in which:

FIG. 1 shows an exemplary loudspeaker array for playback of different sound scenes to a listener at a (first) acoustically controlled location, e.g. during a listening test,

FIGS. 2A and 2B shows a spherical microphone array with 32 capsules (FIG. 2A) and an exemplary sound scene (cocktail party′) being recorded by a microphone array (FIG. 2B),

FIGS. 3A and 3B shows an exemplary listening test setup showing a sound field reproduction system, FIG. 3A illustrating a calibration situation where individual transfer functions are determined, and FIG. 3B illustrating a playback situation, where a recorded sound scene is played for a listener equipped with hearing aids and availed with a test GUI,

FIG. 4 shows a multi-channel de-convolution block diagram for implementing inversion of measured transfer functions [Kirkeby et al.; 1998]),

FIGS. 5A-5C shows sound fields around the head of a listener located at the centre of the loudspeaker array comprising 29 loudspeaker units at different frequencies, (@700 Hz in FIG. 5A, @2.5 kHz in FIG. 5B, and @8 kHz in FIG. 5C, and

FIGS. 6A-6C shows directionality pattern vs. frequency for the microphone array comprising 32 microphone units (@700 Hz in FIG. 6A, @2.5 kHz in FIG. 6B, and @8 kHz in FIG. 6C).

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

In the present section an implementation of a sound filed reproduction system comprising a spherical loudspeaker array comprising 29 loudspeakers and the spherical microphone array comprising 32 microphone capsules is described. The system and method of sound field reproduction in connection with testing of a hearing assistance device are described in detail in [Minaar et al; 2013] from which parts of the following outline are reproduced.

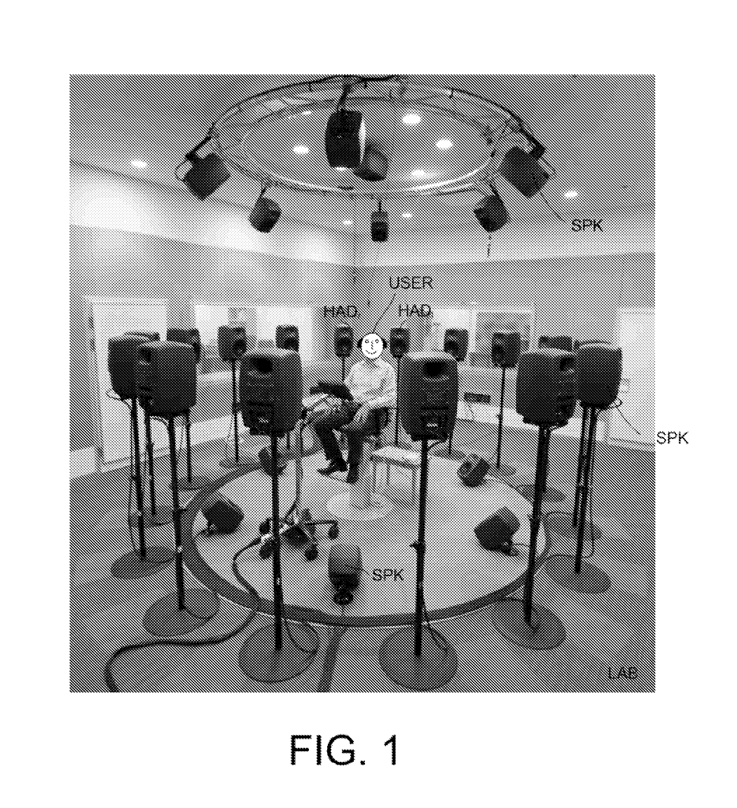

FIG. 1 shows a sound reproduction system, here termed a virtual sound environment (VSE) system, according to present disclosure. The system has Nₛₚₖ=29 loudspeaker units (SPK), placed on a sphere with a radius of 1.9 meters around the listening position (where the user's head (USER) is located). Sixteen loudspeakers are in the horizontal plane, six are 45° below the horizontal plane, six are 45° above the horizontal plane, and one loudspeaker is directly above the listening position. The playback room (LAB) is acoustically damped, with reverberation times of approximately 0.35 s below 500 Hz and 0.2 s above 500 Hz. During a listening test, the listener (USER) is seated on a hydraulic chair that can be raised to ensure that his/her head is in the middle of the loudspeaker sphere, where the sound filed is intended to be optimally reproduced (the ‘optimized volume’). The listener is (in this example) equipped with hearing assistance devices HADₗ and HADᵣ, respectively (e.g. hearing aids to compensate for a hearing impairment, or other hearing assistance devices for augmenting a user's hearing perception in general or in specific situations). In such case, the setup may represent a test system for hearing assistance devices. Otherwise, it may represent a playback facility allowing different sound scenes to be played for one or more (a few, e.g. less than 4, such as less than 2, such as 1) person(s).

The sound scenes to be played in the VSE system can be created either through computer simulations or by recording with a microphone. If the scene is created by computer simulation, it is necessary to construct a three-dimensional model of a room. Sound sources are then placed around the listening position in the simulated room. The scene is created by convolving anechoic signals with calculated spatial room impulse responses (RIRs). During the playback the direct sound and early reflections can be implemented either by 1) the nearest loudspeaker approach or 2) high-order ambisonics (HOA). High-order ambisonics (HOA) is a technology that is based on a spherical harmonics decomposition of three-dimensional sound fields.

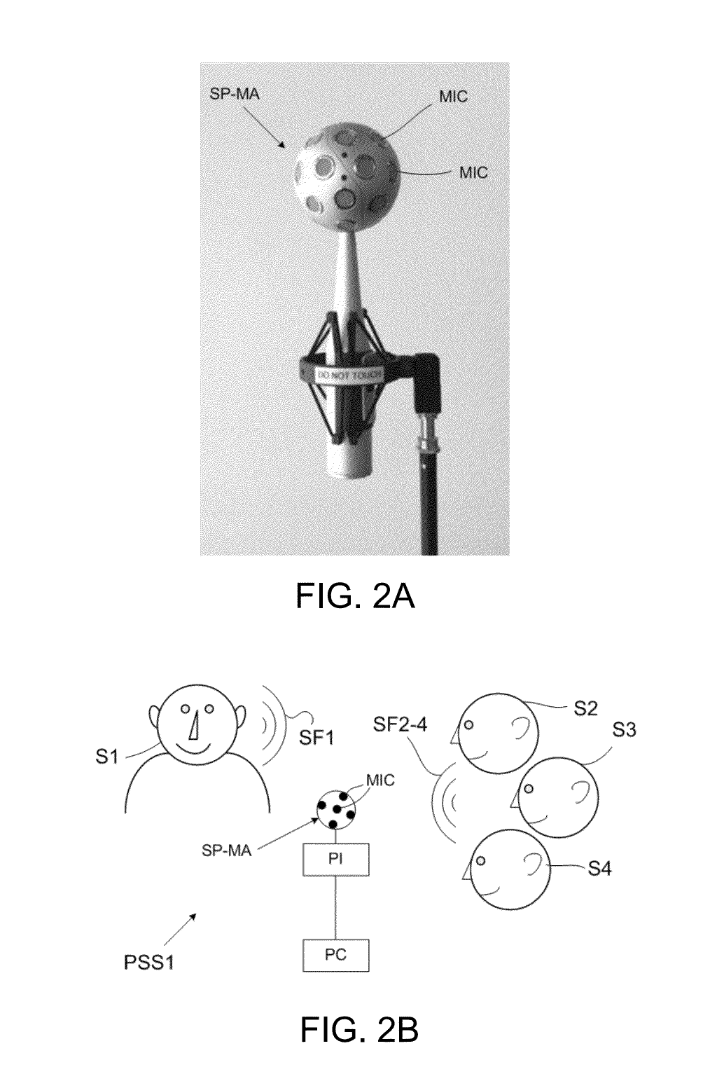

Preferably, the scene is based on an actual listening situation. In this case, the recording can e.g. be made with a spherical microphone array (SP-MA) with 32 microphone capsules (MIC) (from MH Acoustics, Eigenmike) as shown in FIG. 2A.

In order to derive the loudspeaker signals one can use either use 1) high-order ambisonics (HOA) or 2) a direct inversion of measured transfer functions. According to the present disclosure, the second method is used as described in more detail below.

An advantage of using computer modelling is that the sound scenes can be changed rather easily. However, it can be quite cumbersome to construct very convincing real-life situations. On the other hand, recording with a spherical microphone array can give very compelling reproductions of complex scenes. These scenes are not easy to manipulate afterwards, though.

It has previously been shown, that VSE may be useful for testing hearing aids. This is especially since the system is able to create a sound field around the listener's head, which allows for normal head movements.

Due to the limited number of loudspeakers (29) the reconstruction of the sound field is not perfect above ca. 3000 kHz, though. Nonetheless, broadband sounds are localised very accurately. The main advantage of using a VSE over binaural reproduction (through headphones) is that listeners are able to move their heads in the sound field and that the sound is clearly externalised. Thus users can wear hearing aids as they would in real situations (cf. HADₗ, HADᵣ in FIG. 1). By increasing the number of loudspeakers (and correspondingly microphones when recording sound fields to be reproduced by the loudspeakers), an improved performance at higher frequencies can be obtained.

An advantage of a VSE system according to the present disclosure is that it is suitable for testing hearing aid signal processing algorithms in realistic listening situations. In particular, the system is well suited for use with a spherical microphone array and can be applied in an actual listening experiment with listeners wearing hearing aids.

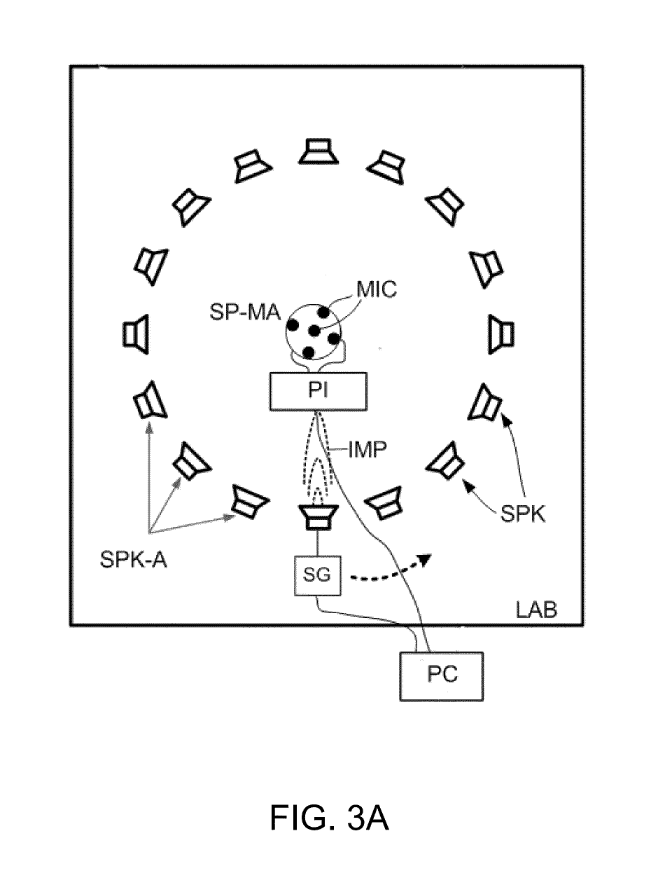

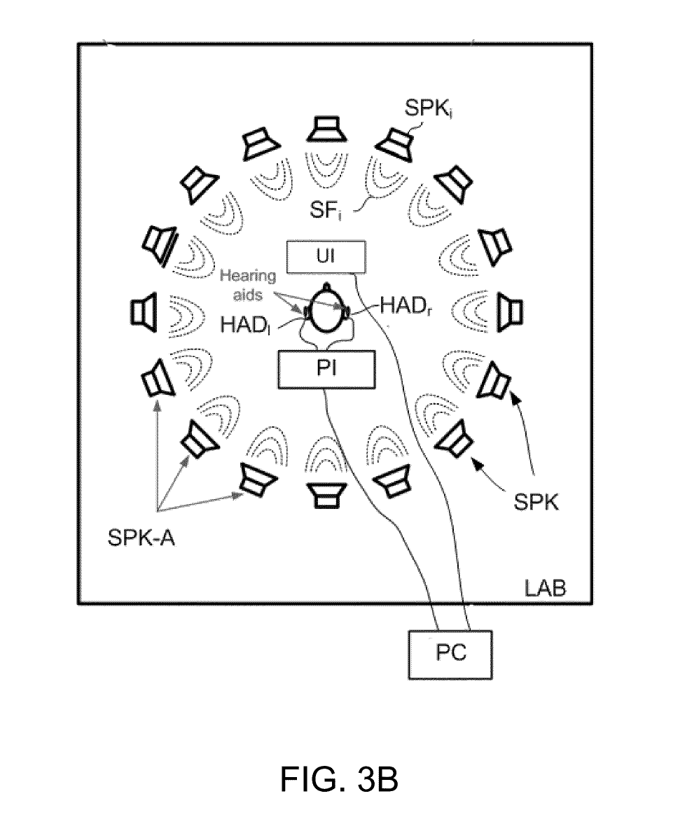

Use of the system firstly presumes defining and recording a number of relevant sound scenes (at respective second locations, typically different from the first location, where the different relevant sound scenes are intended to be played to a listener). An exemplary sketch of such particular sound scene (PSS1) is shown in FIG. 2B, where the spherical microphone array SP-MA is located in a multiple talker environment comprising speakers S1, S2, S3, and S4, each producing a separate contribution SF1, SF2, SF3, and SF4, respectively, to the sound field picked up by the microphone units (MIC) of the microphone array SP-MA. The microphone array (e.g. including each of the microphone units providing N_{mic} separate microphone signals (pr channels), here equal to 32) is connected to a recording unit (e.g. a control unit) PC via a recording interface PI. Thereby all N_{mic} different microphone signals are recorded for a duration of the sound scene and stored for further analysis and use. Secondly, hearing aids are prepared so that settings can be changed in real time, with very low latency. This is illustrated in FIG. 3B where each of the left and right hearing assistance devices (HADₗ, HADᵣ) comprises an interface allowing them to be controlled from a programming device (PC, e.g. a control unit, in FIG. 3B) via programming interface PI. Preferably, the system is configured to allow a user (e.g. the listener or a test manager) to control the hearing assistance devices via a user interface (e.g. the user interface UI of FIG. 3B, and/or another user interface connected to the control unit (PC). Thirdly, the listening test method needs to be implemented so that listeners can evaluate the different settings (algorithms) while listening to the sound scenes (preferably using user interface UI in FIG. 3B).

According to the present disclosure, a microphone array, here exemplified by a spherical microphone array, is integrated with in the VSE system. As mentioned above, the implementation employs direct inversion of measured transfer functions. The method is described in more detail in below. Basically it entails placing the (e.g. spherical) microphone array (SP-MA) in the middle of the loudspeaker array (SPK-A) setup, while located at a first (acoustically) controlled location (LAB), e.g. an acoustically attenuated room (cf. FIG. 3A) and measuring the transfer functions (IMP) from all individual loudspeaker units (SPK) to all microphone capsules (MIC) (as indicated by dashed arrow in FIG. 3A sequentially moving from one speaker unit to the next to measure transfer functions (IMP) by—one at a time—stimulating each speaker unit from a signal generator SG connected to or forming part of control unit PC). In this example, it mounts to 29*32=928 transfer functions in all. This system of transfer functions is then inverted with the multi-channel deconvolution procedure described by [Kirkeby et al.; 1998]. This ensures that, with the given playback system, the sound scenes are reproduced optimally.

The goal of the method of direct inversion of measured transfer functions is to reproduce the signals at all the microphone capsules optimally (in a least squares sense).

In order to create the sound scenes the following steps are performed:
1) In the VSE system, impulse responses (IR) is measured from each loudspeaker to all microphone capsules (928 in all). The IRs were measured with a logarithmic sweep method as described by [Müller and Massarani; 2001]. The lower the reverberation of the playback room, the shorter IR measurement time is needed. In an example with reverberation times of 0.35 s below 500 Hz and 0.2 s above 500 Hz. IRs may be truncated after 23 ms (1024 samples)).
2) This set of measured transfer functions is inverted as described below. Thus it is possible to find an inverted system of optimal filters that give the lowest error in a least squares sense. In the example, these 928 filters also have a filter length of 23 ms (1024 samples), see e.g. [Minaar et al.; 2013].
3) The sound in each scene (listening situation) is recorded with the spherical microphone array. In each situation, the microphone is simply placed in the position where the listeners' head is intended to be.
4) In order to get the loudspeaker signals in each scene, the inverted system of filters is convolved with the corresponding recorded microphone signals.

The resulting playback situation in a controlled first location (LAB) is illustrated in FIG. 3B. Assuming the availability of all calculated loudspeaker signals for a particular sound scene (e.g. as shown in FIG. 2B) allowing each loudspeaker SPKᵢ to produce its own unique (sub-) sound field SFᵢ, these may be played for a user located with his or her head in the optimized volume at the centre of the loudspeaker array SPK-A. In the example of FIG. 3B the user is equipped with left and right hearing assistance devices HADₗ, HADᵣ, (also denoted hearing aids in) which can be conveniently tested with the hearing assistance test system. Each of the hearing assistance devices are (e.g. wirelessly) connected to a control unit PC via a programming interface PI allowing the control of the test (either by the listener or a test manager), including to switch between different processing algorithms in the hearing assistance devices. The test system comprises a user interface UI (operatively, e.g. wirelessly, connected to the control unit PC) allowing the listener to evaluate different processing algorithms in different sound scenes.

Exemplary sound scenes (recorded with the microphone array at their relevant (second) locations), which may be of interest in connection with a hearing assistance test system can be:
Party: You are at a reception with many people and want to listen to the man in front of you (cf. e.g. FIG. 2B).
Restaurant: You are in a canteen and want to follow the conversation on the other side of the table.
Meeting: You are in a meeting room and want to follow the conversation.
Lecture: You are at a lecture and want to follow what the presenter is saying.
Car: You are a passenger on the back seat of a car and want to follow the woman next to you.

As an example, a listening test may be configured to allow test listeners to switch freely between the following four test-conditions (settings) in the hearing aids:
OMNI: Unprocessed signals of the front microphones of the hearing aids.
DIR: The sound is processed by a traditional fixed 2-microphone hypercardiod beamformer.
NR1: An advanced noise reduction algorithm, with its “normal” settings.
NR2: An advanced noise reduction algorithm, with more “aggressive” settings.

The conditions can preferably be level-aligned (equal overall RMS) so-as not to introduce large loudness differences. Likewise, the order of conditions can preferably be randomised and each listening situation (sound scene) e.g. evaluated twice (to increase reliability).

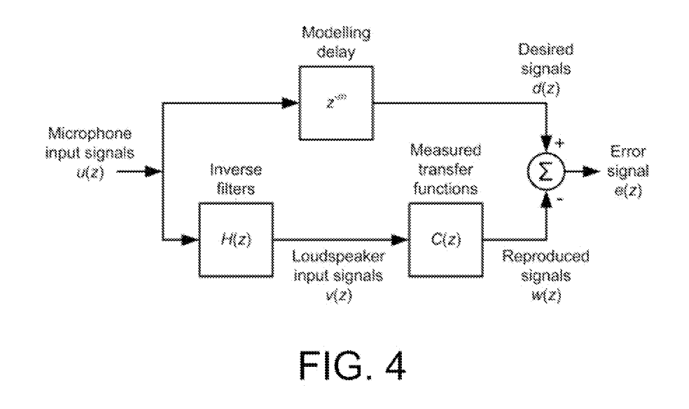

In the case of a multi-channel reproduction system, the inverse filter design problem can be formulated in the z-domain as shown in the block diagram of FIG. 4.

The measured electro-acoustic transfer functions are represented in FIG. 4 by the matrix C(z), which has inverse z-transform c(n). The inverse filters are represented by the matrix H(z), which likewise has inverse z-transform h(n). When the error signal e(n) is zero the system output signal w(n) is a delayed version of the system input signal u(n).

In principle, an infinitely long inverse filter is required. Furthermore, the filter is potentially non-causal since loudspeaker transfer functions generally are not minimum phase functions. In practice, however, a finite filter length is chosen and the modelling delay is applied in the design to ensure that the filters are causal.

In order for the inverse filters to be uniquely defined, the complex variable z is constrained to the unit circle, i.e. |z|=1 and z=e^{jωT}, where T is the sampling period. The problem is solved by defining a cost function, J, as follows:

J(e^{jωT})=e^{H}(e^{jωT})·e(e^{jωT})+βv^{H}(e^{jωT})·v(e^{jωT})

where H denotes the Hermitian operator and β is the regularization parameter. By minimizing the cost function (error) in the least squares sense and using the relations

v(z)=H(z)·u(z)

w(z)=C(z)·v(z)

d(z)=u(z)·z^{-m}

e(z)=d(z)−w(z)

the expression for the inverse filters can be found as

$$H ( z ) = \frac{{C}^{T} ( {z}^{- 1} ) \cdot {z}^{- m}}{{C}^{T} ( {z}^{- 1} ) \cdot C ( z ) + β \cdot I}$$

By taking the inverse z-transform of H(z) causal FIR filters, h(n), can be obtained.

The regularization parameter can be a scalar or a vector and generally has small values. It is particularly useful when the inverse is ill-conditioned, as is the case with most electro-acoustic transfer functions. By increasing β, the poles of the inverse filters are moved away from the unit circle causing the impulse responses to be shorter. It also causes the systems noise gain to be lower, but increases the directional beam width (see below).

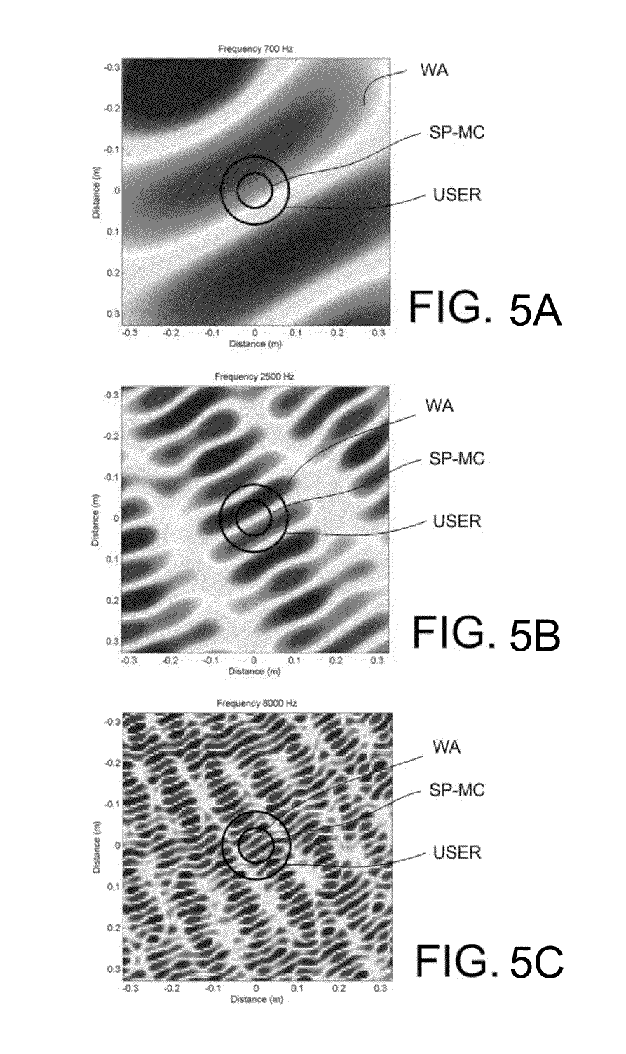

Even though the goal of the method described above is to reproduce the signals at the microphone positions, the sound field (in an ‘optimized volume’) around the microphone is also correct. The extent to which this is true depends on frequency, though. At low frequencies, the sound field is correct in a large area around the microphone (and thus the listener's head, cf. indications of microphone array SP-MC and listener USER in FIGS. 5A-5C). As frequency is increased, this area gets smaller and smaller. With the current system (with 29 loudspeakers and 32 microphones) this area is about the size of a human head at 3 kHz (cf. FIG. 5B). This means that at low frequencies both the amplitude and the phase are correct, whereas at high frequencies the amplitude is correct, but the phase cannot be controlled precisely. Nonetheless, when listening to wideband stimuli, sound localisation is very well reproduced, since low frequency Interaural Time Differences (ITDs) are intact. This is illustrated in FIGS. 5A-5C showing the extension of the sound field around the head of a listener at different frequencies, based on simulations of the sound field system comprising the (spherical) microphone array SP-MC and the loudspeaker array. The results in FIGS. 5A-5C are for a pure tone sound source placed 30° to the left in the horizontal plane, at three different frequencies (@700 Hz in FIG. 5A, @2.5 kHz in FIG. 5B, and @8 kHz in FIG. 5C). The graphs illustrate variations in the sound field over distance [m] in a central cross-section of the optimized volume (−0.3 m-+0.3 m around the centre point in perpendicular directions). The inner circle represents the microphone (SP-MC), whereas the outer circle indicates the size of a human head (USER). Notice that the “sweet spot” (optimized volume) around the head, where the sound field WA resembles plane waves, is quite large at low frequencies (FIG. 5A) and that it gets smaller as the frequency increases (FIGS. 5B-5C).

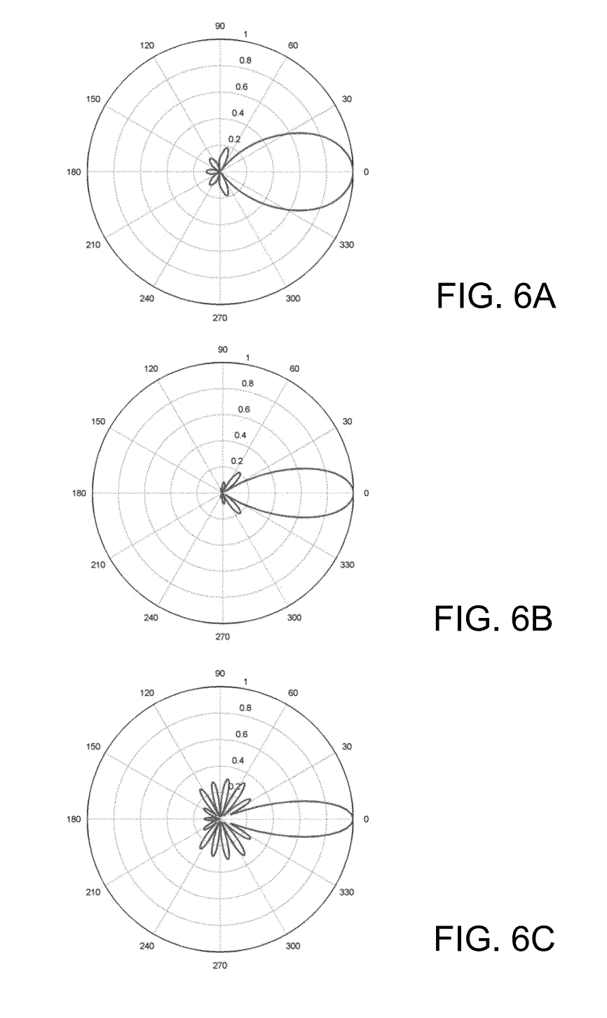

Another parameter that is important to control during the design of the system is the beam width, i.e. the directionality pattern of the system. The beam pattern of the complete system is shown at 3 frequencies in FIGS. 6A-6C. (@700 Hz in FIG. 6A, @2.5 kHz in FIG. 6B, and @8 kHz in FIG. 6C). From the drawings, it can be seen that the main lobe of the beam is largest at low frequencies, whereas it gets narrower as frequency increases. On the other hand, the side lobes tend to increase at the highest frequencies, indicating that sound comes from other directions than the intended direction.

The invention is defined by the features of the independent claim(s).

Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims and equivalents thereof.

### REFERENCES

[Wagner et al.; 2003] K. Wagener, J. L. Jovassen, R. Ardenkjær, “Design, optimization and evaluation of a Danish sentence test in noise”, Int. J. Audiol., Vol. 42, pp. 10-17, 2003.
[Favrot et al.; 2010] S. Favrot, J. M. Buchholz, “Lora: A loudspeaker-based room auralization system”, Acta Acoustica united with Acoustica, Vol. 96(2), pp. 364-375, 2010.
[Daniel; 2000] J. Daniel, “Representation de champs acoustiques, application a la transmission et a la reproduction de scenes sonores complexes dans un context multimedia”, PhD thesis (in French), Universite Paris 6, France, 2000.
US7336793B2 (HARMAN INT.) 11 Nov. 2004
US20010040969A1 (Revit, Schulein) 15 Nov. 2001
[Kirkeby et al.; 1998] O. Kirkeby, P. A. Nelson, H. Hamada and F. Orduna-Bustmante, “Fast deconvolution of multichannel systems using regularization”, IEEE Transactions of Speech and Audio Processing, Vol. 6, No. 2, pp. 189-194, 1998.
[Minaar et al.; 2013] P. Minnaar, S. F. Albeck, C. S. Simonsen, B. Søndersted, S. A. D. Oakley and J. Bennedbæk, “Reproducing real-life listening situations in the laboratory for testing hearing aids”, Paper no. 8951, To be presented at the 135th Convention of the Audio Engineering Society, New York, USA, October 2013.
[Fazi and Nelson; 2007] F. M. Fazi and P. A. Nelson, “The ill-conditioning problem in sound field reconstruction”, 123rd AES Convention, New York, USA, October 2007.
[Chang et al.; 2010] J-H. Chang, M-H. Song, J-Y. Park, T-W. Lee and Y-H. Kim, “Sound field reproduction by using a scatterer”, 20th ICA Conference, Sydney, Australia, August 2010.
[Duda and Martens] Duda, Richard O., Martens, William L., “Range dependence of the response of a spherical head model”, The Journal of the Acoustical Society of America, Volume 104, Issue 5, November 1998, pp. 3048-3058.
[Schaub; 2008] Arthur Schaub, Digital hearing Aids, Thieme Medical. Pub., 2008.
[Müller and Massarani; 2001] S. Müller and P. Massarani, “Transfer function measurement with sweeps”, J. Audio Eng. Soc., Vol. 49, No. 6, pp. 443-471, June 2001.

1. A method of reproducing an acoustical sound field to a listener at a first location using a sound reproduction system comprising a microphone array comprising a plurality of microphone units and a loudspeaker array comprising a plurality of loudspeaker units, the method comprising
1) Determining a transfer function from each loudspeaker unit of the loudspeaker array to all microphone units of the microphone array, thereby providing a set of transfer functions, when said microphone array is located in a primary volume at an intended position of the listener's head during listening to said sound field;
2) Inverting the set of transfer functions and determining a system of optimal filters;
3) Placing the microphone array in an intended position of the listener's head in a particular sound scene at a second location and recording sound of the particular sound scene at the second location, thereby providing a particular sound scene recording;
4) Determining the loudspeaker signals of the particular sound scene configured to be played to the listener at the first location by the loudspeaker array by convolving the inverted system of optimal filters with the recorded signals.

2. A method according to claim 1 wherein the first location has predefined acoustic properties.

3. A method according to claim 1, wherein the second location is different from the first location.

4. A method according to claim 1, wherein the second location comprises a location of a particular sound scene representing an intended listening situation.

5. A method according to claim 1, wherein the second location comprises a particular sound scene representing an intended listening situation of a user of a hearing assistance device or a hearing assistance system.

6. A method according to claim 1, wherein step 1) comprises 1 a) Positioning the microphone array and the loudspeaker array in a predetermined geometrical configuration, the microphone array being placed at an intended position of a listener's head when listening to said acoustical sound field.

7. A method according to claim 1, wherein step 1) comprises measuring at least some of said transfer functions.

8. A method according to claim 1, wherein step 1) is performed at said first location.

9. A method according to claim 1, wherein step 1) is performed at the location where the particular sound scene recording of step 3) is intended to be presented to the listener.

10. A method according to claim 1, wherein step 1) comprises that some, such as a majority or all of said transfer functions are measured.

11. A method according to claim 1, wherein step 1) comprises theoretically determining at least some of said transfer functions.

12. A method according to claim 1, wherein step 3) is repeated to provide a number N_{ssc} of particular sound scene recordings.

13. A method according to claim 1, wherein said listener wears a hearing assistance system configured to pick up and process said acoustic sound field.

14. A method of testing a hearing assistance system in a sound field, the hearing assistance system comprising one or more hearing assistance devices adapted for being fully or partially located on or implanted in the head of a listener, the method comprising the steps of the method according to claim 1, the method further comprising:
T1) Providing the listener with said one or more hearing assistance devices;
T2) Locating the listener at said first location so that the listener's head is positioned in said primary volume;
T3) Providing one or more of said particular sound scene recordings;
T4) Playing said one or more particular sound scene recordings for the user.

15. A method according to claim 14 comprising providing a user interface accessible to the listener, wherein the user interface is configured to allow the listener to indicate an opinion on the currently played particular sound scene recording.

16. A method according to claim 14 comprising providing a user interface configured to allow the listener to switch between different processing algorithms.

17. A hearing assistance test system comprising a sound reproduction system and a control unit suited for testing a hearing assistance system of a user at a first location,
the sound reproduction system comprising
A loudspeaker array comprising a plurality of loudspeaker units, the loudspeaker array being adapted to be located in a predefined geometrical configuration surrounding said listener;
A control unit operatively connected to said loudspeaker array and configured to play individual loudspeaker signals of each loudspeaker unit of the loudspeaker array of a particular sound scene as determined according to the method of claim 1, said individual loudspeaker signals being configured to be played to the listener when said listener is located at said first location; the control unit comprising
a listener user interface allowing said listener to interact with the control unit.

18. A hearing assistance test system according to claim 17 wherein the control unit comprises a programming interface to said hearing assistance system allowing a user to modify processing in the hearing assistance system.

19. A hearing assistance test system according to claim 17 wherein the hearing assistance test system is configured to allow the listener to modify the processing in the hearing assistance system e.g. in the one more hearing assistance devices via the listener user interface.

20. A data processing system comprising a processor and program code means for causing the processor to perform at least some of the steps of the method of claim 1.
